(19) United States
(12) Patent Application Publication
(10) Pub. No.: US 2026/0093433 A1
(43) Pub. Date: Apr. 2, 2026

(54) CONTROL METHOD AND DISPLAY DEVICE

(71) Applicant: SEIKO EPSON CORPORATION, Tokyo (JP)

(72) Inventor: Katsuyoshi YAMAGUCHI, MATSUMOTO-SHI (JP)

(21) Appl. No.: 19/341,445

(22) Filed: Sep. 26, 2025

(30) Foreign Application Priority Data
Sep. 30, 2024 (JP) 2024-170129

(51) Int. Cl. G06F 3/14; G06F 3/147

(52) U.S. Cl. CPC G06F 3/1423; G06F 3/1407; G06F 3/1454; G06F 3/147

(57) ABSTRACT

A display device that establishes first communication with a first device via a wired cable and is capable of communicating with a second device; includes the first device and the display device are capable of communicating with each other via a network; the first device does not store an application program, and the second device stores an application program; wherein the display device transmitting information indicating that the second communication is requested to the first device via the network or the wired cable when information requesting the second communication between the second device and the display device is received from the second device by the application program while the first image is displayed in the display region; and establishing the second communication when information indicating that the second communication was accepted is received from the first device via the network or the wired cable.

The present application is based on, and claims priority from JP Application Serial Number 2024-170129, filed Sep. 30, 2024, the disclosure of which is hereby incorporated by reference herein in its entirety.

### BACKGROUND

### 1. Technical Field

The present invention relates to a control method and a display device.

### 2. Related Art

Conventionally, in order for a device such as a computer to display an image on a display device such as a projector, communication between the device such as a computer and the display device is established. For example, JP-A-2018-152663 discloses that a projector displays an image including an identification code on a projection surface in response to a predetermined operation such as turning on power, and a user of the projector inputs the identification code displayed on the projection surface into an information terminal, thereby causing the projector to establish communication with the information terminal.

However, when a plurality of devices are connectable to one display device, the following problem arises. Specifically, a situation may occur in which a device with which communication has not been established requests communication with the display device while the display device is displaying an image based on image data transmitted from a device with which communication has already been established. In this situation, if the display device executes a predetermined operation and displays an image including the identification code, there is a problem that the display of an image based on image data transmitted from the device with which communication is established is interfered with.

### SUMMARY

A control method according to an aspect of the present disclosure is a control method for a display system including a first device, a second device, and a display device that establishes first communication with the first device via a wired cable, is configured to communicate with the second device, and is configured to display an image in a display region, the first device and the display device are configured to communicate with each other via a network, the first device does not store an application program, the second device stores the application program, and the control method including when information from the second device requesting a second communication between the second device and the display device is received by the application program while a first image is being displayed in the display region, transmitting, to the first device via the network or the wired cable, information indicating that the second communication was requested and when information indicating that the second communication was accepted is received from the first device via the network or the wired cable, establishes the second communication.

A display device according to an aspect of the present disclosure is a display device that establishes first communication with a first device via a wired cable, that is configured to communicate with a second device, and that is configured to display an image in a display region, the first device and the display device are configured to communicate with each other via a network, the first device does not store an application program, the second device stores the application program, and when information requesting a second communication between the second device and the display device is received from the second device by the application program while the first image is being displayed in the display region, the display device transmits information indicating that the second communication was requested to the first device via the network or the wired cable and when information indicating that the second communication was accepted is received from the first device via the network or the wired cable, the display device establishes the second communication.

### BRIEF DESCRIPTION OF THE DRAWINGS

FIG. 1 is a diagram showing a display system 1 according to a first embodiment.

FIG. 2 is a diagram showing an example of a configuration of an information processing device 10.

FIG. 3 is a diagram showing an example of a configuration of a projector 20.

FIG. 4 is a sequence diagram for explaining an example of an operation of the display system 1.

FIG. 5 is a sequence diagram for explaining an example of an operation of the display system 1.

FIG. 6 is a flowchart showing an example of an operation of the projector 20.

FIG. 7 is a flowchart showing an example of a process for when receiving a communication request.

FIG. 8 is a flowchart showing an example of an authorization request information transmission process.

FIG. 9 is a flowchart showing an example of a wired management authority device setting process.

FIG. 10 is a diagram showing an example of a communication determination dialog DW.

FIG. 11 is a diagram showing an example of a screen EW.

FIG. 12 is a diagram showing an example of a communication determination image CW.

FIG. 13 is a flowchart showing an example of an authorization request information transmission process in a first modification.

FIG. 14 is a flowchart showing an example of an authorization request information transmission process in a second modification.

### DESCRIPTION OF EMBODIMENTS

Hereinafter, embodiments of the present disclosure will be described with reference to the drawings. In the drawings, the dimensions and scales of the sections are different from the actual ones as appropriate. In addition, the embodiments described below are preferred specific examples of the present disclosure, and thus various technically preferable limitations are added thereto, but the scope of the present disclosure is not limited to these embodiments unless there is a description to particularly limit the present disclosure in the following description.

### 1. First Embodiment

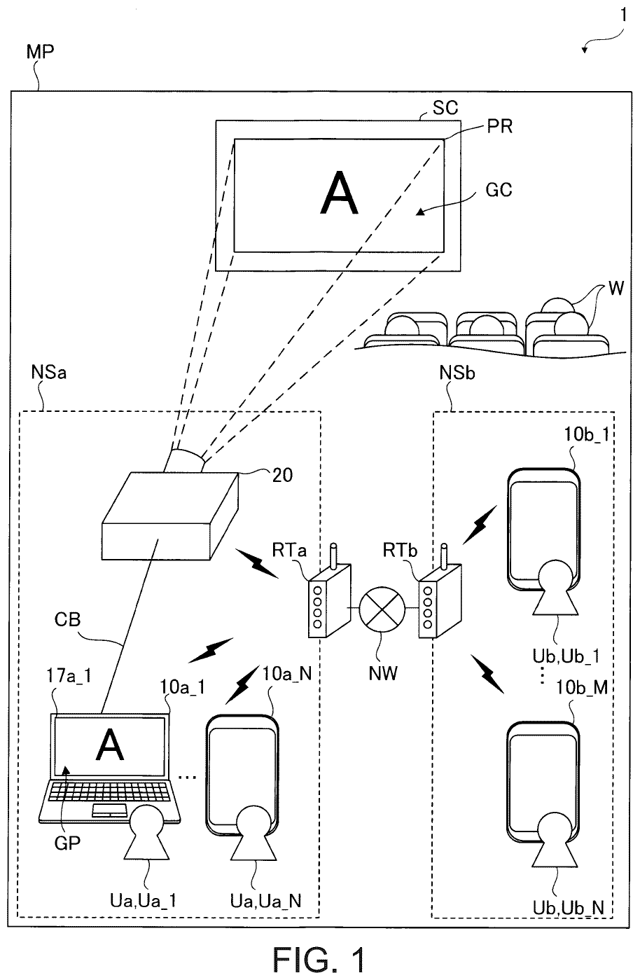

FIG. 1 is a diagram showing a display system 1 according to a first embodiment. The display system 1 is a system that projects an image GC on a projection region PR of a projection surface SC viewed from one or a plurality of spectators W in a venue MP, and that allows any of two or more presenters U to give an explanation regarding the image GC. The venue MP is a place where an event in which the spectators W gather is held, and may be either an indoor place or an outdoor place. The spectator W is a specific or unspecified person. However, the spectators W may not be present, and the presenter U other than the presenter U who is currently giving an explanation among the two or more presenters U may temporarily be a spectator. The event is, for example, a conference, a lecture, a class, or the like. In the present embodiment, it is assumed that two or more presenters U sequentially give explanations.

As shown in FIG. 1, the display system 1 includes N information processing devices 10a, M information processing devices 10b, a projector 20, a router RTa, and a router RTb. In the following description, the information processing device 10a and the information processing device 10b may be referred to as the information processing device 10 without being distinguished from each other. N and M are integers of 1 or more. Therefore, the display system 1 includes two or more information processing devices 10. N and M are different numbers from each other, but may be the same number as each other. The information processing device 10 is a computer such as a PC or a smartphone. PC is an abbreviation for Personal Computer. The ia-th information processing device 10a_ia among the N information processing devices 10a is operated by the ia-th presenter Ua_ia among N presenters, where ia is an integer from 1 to N. The ib-th information processing device 10a_ib among the M information processing devices 10b is operated by the ib-th presenter Ub_ib among the M presenters, where ib is an integer from 1 to M. Hereinafter, the N presenters Ua and the M presenters Ub may be referred to as a presenter U without distinction. In this embodiment, for the sake of simplicity, the presenter U will explain the image GC projected onto the projection region PR, but the person operating the information processing device 10 and the person explaining the image GC may be different persons. Projecting an image is an example of “displaying an image”. The projector 20 is an example of a “display device”. The projection region PR is an example of a “display region”.

As shown in FIG. 1, the N information processing devices 10a and the projector 20 belong to a network NSa, and the M information processing devices 10b belong to a network NSb. The router RTa is a device that relays communication between a device inside the network NSa and a device outside the network NSa. The router RTb is a device that relays communication between a device inside the network NSb and a device outside the network NSb. The router RTa and the router RTb communicate with each other via a network NW such as a LAN, a WAN, or the Internet. LAN is an abbreviation for Local Area Network. WAN is an abbreviation for Wide Area Network. The network NSa is an example of a “network”. The router RTa and the router RTb may be able to directly communicate with each other without passing through the network NW.

The projector 20 can communicate with the N information processing devices 10a and the M information processing devices 10b. In detail, the information processing device 10a_1 can communicate with the projector 20 via the wired cable CB. Among the N information processing devices 10a, the information processing devices 10a other than the information processing device 10a_1 can communicate with the projector 20 by wireless communication via the router RTa. Examples of the wireless communication include Wi-Fi, Bluetooth, and ZigBee. Wi-Fi and Bluetooth are registered trademarks. Furthermore, the M information processing devices 10b can communicate with the projector 20 via the router RTb and router RTa.

As in the display system 1, the following two situations are examples of a situation in which wired communication and wireless communication are mixed as an aspect of communication with the projector 20. A first situation in which wired communication and wireless communication are mixed is when the display system 1 includes a device such as a smartphone that does not generally perform communication using the wired cable CB. A second situation in which the wired communication and the wireless communication are mixed is a case where the venue MP is large and the information processing device 10 cannot communicate with the projector 20, the router RTa, or the router RTb via the wired cable CB.

The display system 1 is applied to, for example, the following two situations. In a first situation in which the display system 1 is applied, the event is a conference, and the presenter Ua_1 is the organizer of the conference and provides an overall description of the conference. The presenter Ua_2 to Ua_N and the presenter Ub_1 to Ub_M give explanations according to the agenda of each presenter. In the second situation to which the display system 1 is applied, the event is a class, the presenter Ua_1 is a teacher who is in charge of the class, and the presenters Ua_2 to Ua_N and the presenters Ub_1 to Ub_M are students who take the class. The teacher who is the presenter Ua_1 explains the content of the assignment given to the student in the class before this class. The presenter Ua_2 to Ua_N and the presenter Ub_1 to Ub_M explain the answers to the assignment. In the following, for ease of understanding, it is assumed that the first presenter U to give a presentation is presenter Ua_1, then presenter Ub_1 gives a presentation after presenter Ua_1, and then presenter Ub_2 gives a presentation after presenter Ub_1.

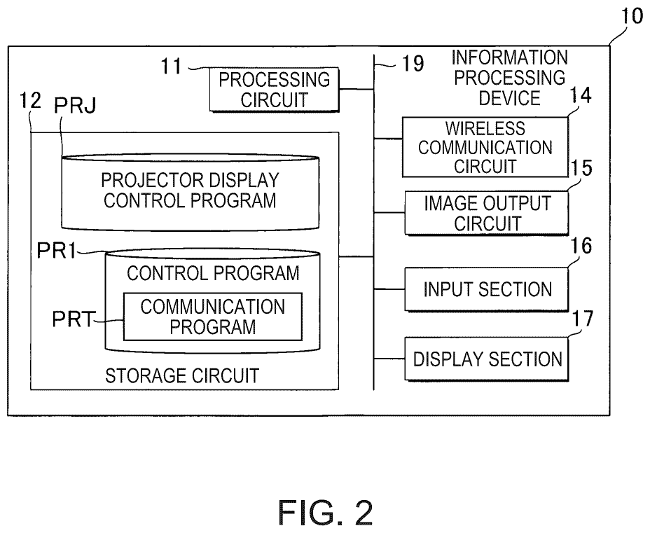

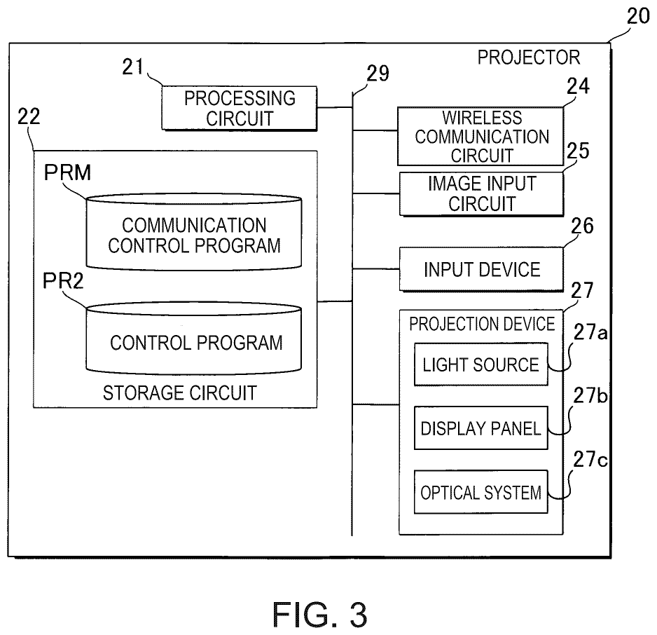

The configurations of the information processing device 10 and the projector 20 will be described with reference to FIGS. 2 and 3.

FIG. 2 is a diagram showing an example of a configuration of the information processing device 10. The information processing device 10 includes at least one processing circuit 11, a storage circuit 12, a wireless communication circuit 14, an image output circuit 15, an input section 16, and a display section 17. The processing circuit 11, the storage circuit 12, the wireless communication circuit 14, the image output circuit 15, the input section 16, and the display section 17 are connected to each other by a bus 19 for communicating information.

The processing circuit 11 is a processing circuit such as a CPU or an FPGA. CPU is an abbreviation for Central Processing Unit. FPGA is an abbreviation for Field Programmable Gate Array. The processing circuit 11 may be configured by one or more processors.

The storage circuit 12 is configured by a magnetic storage device, a flash ROM, or the like. The storage circuit 12 is a recording medium readable by the processing circuit 11, and stores a plurality of programs including a projector display control program PRJ and a control program PR1 executed by the processing circuit 11, as well as various kinds of information used by the processing circuit 11, and the like. The projector display control program PRJ is an application program for controlling projection by the projector 20. For example, the information processing device 10 downloads the projector display control program PRJ from a server managed by a developer of the projector 20. The control program PR1 is a system program including an OS and the like of the information processing device 10. OS is an abbreviation for Operating System. Further, the control program PR1 includes a communication program PRT. The communication program PRT is a program for performing communication related to the operation of the display system 1 between the devices included in the display system 1. The projector display control program PRJ is an example of an “application program”.

However, the projector display control program PRJ is not stored in the storage circuit 12 of the information processing device 10a_1. The reason why the projector display control program PRJ is not stored in the storage circuit 12 of the information processing device 10a_1 will be described later.

The wireless communication circuit 14 is hardware having a communication circuit for performing wireless communication with other devices. The wireless communication circuit 14 may include, for example, a connector or an antenna corresponding to a communication standard such as wireless communication via Wi-Fi, infrared communication, and Bluetooth, and a communication circuit.

The image output circuit 15 is an interface that transmits image data via the wired cable CB. Specifically, the image output circuit 15 is a circuit that outputs an image signal confirming to a standard such as HDMI and DVI. HDMI is a registered trademark and is an abbreviation for High-Definition Multimedia Interface. DVI is an abbreviation for Digital Visual Interface. In a case where the wired cable CB is a cable that complies with USB Type-C and the wired cable CB operates in the alternate mode of USB Type-C, the image output circuit 15 may be a USB communication circuit. USB is an abbreviation for Universal Serial Bus.

The input section 16 is a device for the presenter U who operates the information processing device 10 to input information. The input section 16 is, for example, a mouse and a keyboard if the information processing device 10 is a PC, and is a physical button if the information processing device 10 is a smartphone.

The display section 17 is a device that displays an image based on image data transmitted by the processing circuit 11. For example, the display section 17 is an LCD or an organic EL display. LCD is an abbreviation for Liquid Crystal Display. EL is an abbreviation for Electro Luminescence. The input section 16 and the display section 17 may be integrated. A configuration in which the input section 16 and the display section 17 are integrated is, for example, a touchscreen.

In the following description, for i being any integer from 1 to N, each element of the information processing device 10a_i may be described by assigning the reference symbol “a_i”. For example, the display section 17 included in the information processing device 10a_i may be referred to as a display section 17a_i in some cases. Similarly, for j being any integer from 1 to M, each element of the information processing device 10b_j may be described by assigning the reference symbol “b_j”. For example, the display section 17 included in the information processing device 10b_j may be referred to as a display section 17b_j in some cases.

The information processing device 10a_1 includes the image output circuit 15, but the information processing devices 10 other than the information processing device 10a_1 may not include the image output circuit 15. The information processing device 10a may be capable of communicating with the router RTa by wired communication such as a LAN cable. Similarly, the information processing device 10b may be capable to communicating with the router RTb by wired communication such as a LAN cable.

FIG. 3 is a diagram showing an example of a configuration of the projector 20. The projector 20 includes at least one processing circuit 21, a storage circuit 22, a wireless communication circuit 24, an image input circuit 25, an input device 26, and a projection device 27. The processing circuit 21, the storage circuit 22, the wireless communication circuit 24, the image input circuit 25, the input device 26, and the projection device 27 are connected to each other via a bus 29 for communicating information.

The processing circuit 21 is a processing circuit such as a CPU, a system on chip (SoC), or an FPGA. The processing circuit 21 may be configured by one or more processors.

The storage circuit 22 is configured by a magnetic storage device, a flash ROM, or the like. The storage circuit 22 is a recording medium readable by the processing circuit 21, and stores a plurality of programs including a control program PR2 and a communication control program PRM, as well as various types of information used by the processing circuit 21. The control program PR2 is a system program including an OS of the projector 20. The communication control program PRM is a program for controlling an operation of the projector 20 in the display system 1.

The wireless communication circuit 24 is hardware having a communication circuit for performing wireless communication with other devices. The wireless communication circuit 24 may include, for example, a connector or an antenna corresponding to a communication standard such as wireless communication via Wi-Fi, infrared communication, and Bluetooth, and a communication circuit.

The image input circuit 25 is an interface that transmits image data via the wired cable CB. Specifically, the image input circuit 25 is a circuit that outputs an image signal that complies with the same standard as that of the image output circuit 15.

The input device 26 is a device for the presenter U to input information. The input device 26 is a plurality of buttons including, for example, a function list display key, an up key, a down key, a left key, a right key, a determination key, and a cancel key. Alternatively, the input device 26 may be configured by one or more types of devices such as a pointing device and a touchscreen. Alternatively, the projector 20 may communicate with a remote controller including a plurality of buttons described above instead of the input device 26.

The projection device 27 is a device that projects the image GC on the projection region PR based on image data transmitted from the processing circuit 21. The projection device 27 includes a light source 27a, a display panel 27b, and an optical system 27c.

The light source 27a includes a light source such as a halogen lamp, a xenon lamp, an ultra-high pressure mercury lamp, an LED, or a laser light source, and emits red, green, and blue light, respectively. LED is an abbreviation for Light Emitting Diode. The display panel 27b is a light modulation device including three light modulation elements provided corresponding to red, green, and blue. Each of the light modulation elements includes, for example, a transmissive liquid crystal panel, a reflective liquid crystal panel, a digital mirror device, or the like, and generates image light of each color by modulating light of the corresponding color. The image lights of the respective colors generated by the display panel 27b are combined by a color combining optical system to become full-color image light. The optical system 27c is a projection optical system including a projection lens and the like that forms and projects full-color image light from the display panel 27b into the image GC on the projection region PR.

The projector 20 may be able to communicate with the router RTa by wired communication such as a LAN cable, in the same way as the information processing device 10a.

The description returns to FIG. 1. In the example shown in FIG. 1, the projector 20 communicates with the information processing device 10a_1, and the image GP displayed on the display section 17a_1 and the image GC projected on the projection region PR are the same.

In this specification, when image GP and image GC are identical, it means that the image data transmitted to the display section 17 by the processing circuit 11 of any information processing device 10 among the N information processing devices 10a and the M information processing devices 10b is identical to the image data transmitted to the projection device 27 by the processing circuit 21. Therefore, even when the color reproducibility of the display section 17 and the color reproducibility of the projection device 27 are different from each other, if image data transmitted from the processing circuit 11 to the display section 17 and image data transmitted from the processing circuit 21 to the projection device 27 are the same, the image GP and the image GC are regarded as being the same.

The reason why the projector display control program PRJ is not stored in the storage circuit 12 of the information processing device 10a_1 is that image data indicating the image GP displayed on the display section 17 of the information processing device 10a_1 is transferred via a wired cable CB, and the projector 20 projects the image GC indicated by this image data.

### 1-2. In Progression of Event

During the progress of the event, while the presenter Ua_1 is explaining about the image GC, there is a request for the presenter Ub_1 who makes a presentation next to the presenter Ua_1 to prepare for projection on the projector 20. An example of the preparation for projection is to establish communication between the information processing device 10b_1 and the projector 20. Establishing communication means setting a communication path between a PC or a smartphone and a projector before starting data transfer. Establishing communication via the wired cable CB means that a wired communication establishment process is executed corresponding to the wired cable CB, thereby setting a communication path between a PC and a projector. For example, when the wired cable CB is compliant with HDMI, the wired cable CB includes an HPD line connected to a pin called HPD. HPD is an abbreviation for Hot Plug Detect. The information processing device 10 executes detection processing of detecting the connection of the projector 20 using the HPD line. In a case where the wired cable CB complies with the USB, the information processing device 10 and the projector 20 can communicate with each other by executing USB enumeration between the information processing device 10 and the projector 20. The detection process in the HDMI and the USB enumeration in the USB may be collectively referred to as a wired communication establishment process according to the wired cable CB.

The establishment of the communication in the wireless communication is that the information processing device 10 logs in to a service in which the projector 20 projects an image. Alternatively, the establishment of the communication may be performed by performing three way handshake in a case where TCP is used in the communication between the information processing device 10 and the projector 20. TCP is an abbreviation for Transmission Control Protocol. Once communication is established, the information processing device 10 can access the projector 20, and the presenter U can prepare for projection. In the following description, establishing communication between the information processing device 10 and the projector 20 in wireless communication may be referred to as “the information processing device 10 logs in to the projector 20”.

In general, the time available for the presenter U to give a presentation is allocated in advance. In a case where a problem occurs in which the information processing device 10b_1 cannot log in to the projector 20, if it takes a long time to solve the problem, there is a risk that the time available for the presenter Ub_1 to give a presentation will be shortened. Therefore, the information processing device 10b_1 logs in the projector 20 while the presenter Ua_1 is giving a presentation on the image GC, the presenter Ub_1 can smoothly continue the presentation after the presenter Ua_1 has finished the presentation.

As a method of the information processing device 10 log in to the projector 20, the information processing device 10 displays an image including an identification code in the projection region PR in accordance with a predetermined operation such as power on. The presenter U inputs the identification code displayed in the projection region PR to the information processing device 10, and thus the information processing device 10 logs in to the projector 20.

In order for the information processing device 10b_1 to log in to the projector 20, a situation is conceivable in which the information processing device 10b_1 requests the projector 20 to communicate with the projector 20 while the presenter Ua_1 is explaining about the image GP. In this situation, if the projector 20 displays the image including the identification codes in the projection region PR, there is a problem that the display of the image GP based on the image data transmitted from the information processing device 10a_1 will be interfered with. When the display of the image GP based on the image data transmitted from the information processing device 10a_1 is interfered with, the presenter Ua_1 cannot proceed with the explanation about the image GP. Further, the presenter Ua_1 needs to explain to the spectators W that the image including the identification code is unrelated to the content being explained by the presenter Ua_1.

Since the projector display control program PRJ is not stored in the storage circuit 12 of the information processing device 10a_1, the information processing device 10a_1 and the information processing device 10b_1 cannot communicate with each other using the function of the projector display control program PRJ.

Therefore, in the display system 1 of this embodiment, when the projector 20 is requested by the information processing device 10b_1 to communicate between the information processing device 10b_1 and the projector 20, the projector 20 notifies the information processing device 10a_1 via the wired cable CB of authorization request information indicating that this communication was requested. The authorization request information is an example of “information indicating that a request was made”.

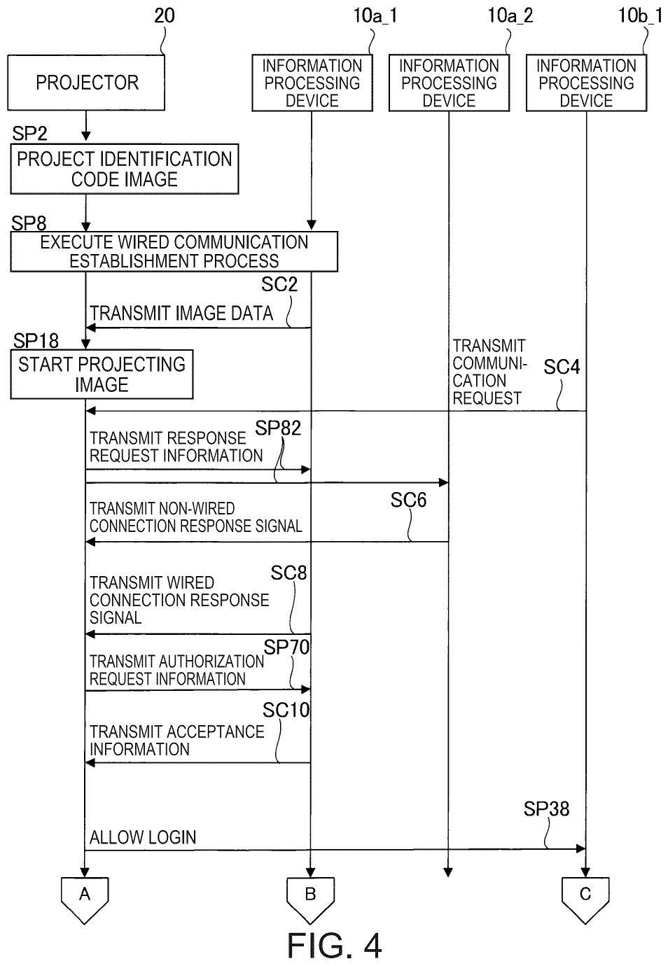

When the authorization request information is received, the information processing device 10a_1 outputs, to the display section 17 of the information processing device 10a_1, information for allowing the presenter Ua_1 to determine whether or not to accept communication between the information processing device 10b_1 and the projector 20. The information for allowing the presenter Ua_1 to determine whether or not to accept the communication between the information processing device 10b_1 and the projector 20 is, for example, a character string indicating whether or not to accept the communication between the information processing device 10b_1 and the projector 20. In the following description, the information processing device 10a_1 displays a dialog including the character string on the display section 17, and the dialog may be referred to as a “communication determination dialog”. When the projector 20 receives, from the information processing device 10a_1, the information indicating that the communication between the information processing device 10b_1 and the projector 20 was accepted, the information processing device 10b_1 logs in the projector 20. Since the communication determination dialog is not displayed in the projection region PR, the presenter Ua_1 can smoothly proceed with the explanation regarding the image GP. The operation of the display system 1 will be described with reference to FIGS. 4, 5, and 6.

### 1-3. Operation of Display System 1

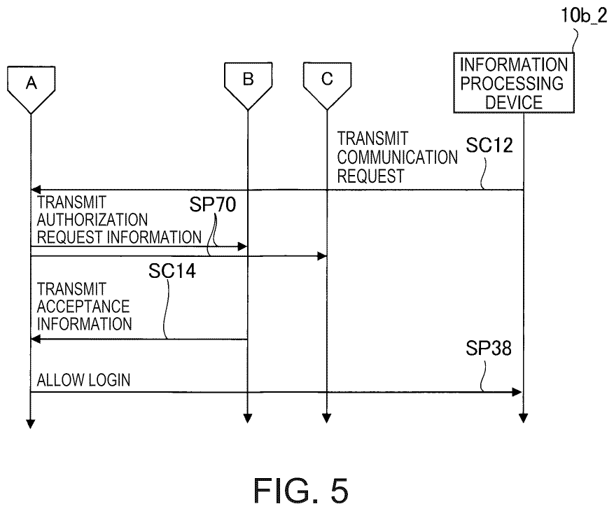

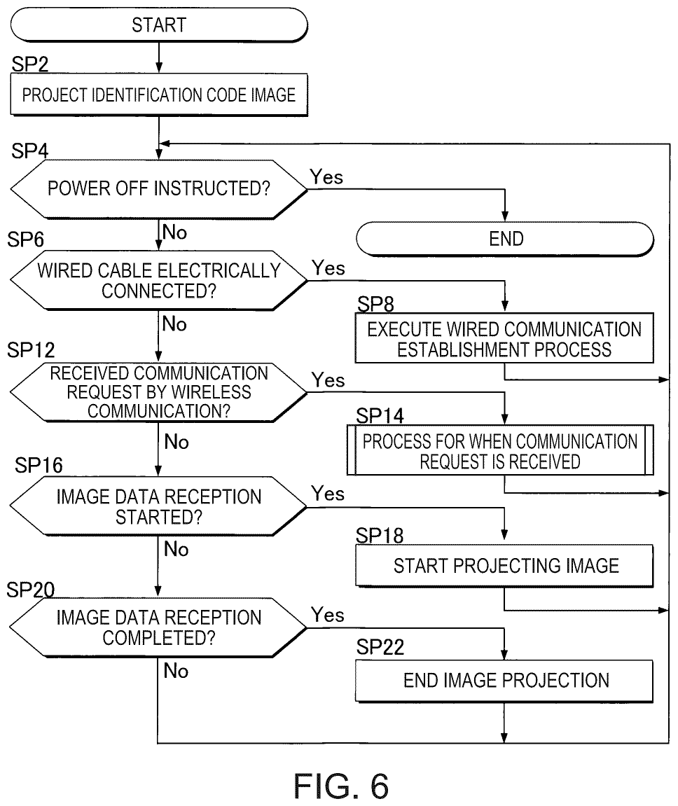

FIGS. 4 and 5 are sequence diagrams for explaining an example of the operation of the display system 1. FIG. 6 is a flowchart showing an example of an operation of the projector 20. In FIGS. 4 and 5, it is assumed that the information processing devices 10a included in the network NSa are the information processing device 10a_1 and the information processing device 10a_2, and the information processing devices 10b included in the network NSb are the information processing device 10b_1 and the information processing device 10b_2. However, in FIG. 4, there is no processing of the information processing device 10b_2 so illustration is omitted, and in FIG. 5, there is no processing of the information processing device 10a_2 so illustration is omitted.

In the first embodiment, management authority of the projector 20 is set in the information processing device 10 that established communication with the projector 20. Then, the projector 20 causes the presenter U of the information processing device 10 to which management authority is set to determine whether or not to accept communication with the projector 20. Hereinafter, the information processing device 10 to which management authority was set may be referred to as a “management authority device”. The value that the number of management authority devices can take is an integer of 0 or more. There are two types of management authority devices, wired management authority devices and wireless management authority devices. The wired management authority device is the information processing device 10 that has established communication with the projector 20 via the wired cable CB. The wireless management authority device is the information processing device 10 that has established communication with the projector 20 by wireless communication.

In the following description, the information processing device 10a_1 corresponds to a “first device”, the information processing device 10b_1 corresponds to a “second device”, and the information processing device 10b_2 corresponds to a “third device”. The communication between the information processing device 10a_1 and the projector 20 corresponds to “first communication”. The communication between the information processing device 10b_1 and the projector 20 corresponds to “second communication”. The communication between the information processing device 10b_2 and the projector 20 corresponds to “third communication”.

The processing circuit 21 of the projector 20 reads out the communication control program PRM from the storage circuit 22 and executes the read out communication control program PRM to thereby execute the operations shown in FIGS. 4, 5, and 6. The information processing device 10 other than the information processing device 10a_1 read out the projector display control program PRJ and execute the read out projector display control program PRJ, thereby executing the operations shown in FIGS. 5 and 6. The information processing device 10a_1 executes the control program PR1 to execute the operations shown in FIGS. 5 and 6.

As shown in FIGS. 4 and 6, in step SP2, after power-on, the processing circuit 21 projects an identification code image including an identification code on the projection region PR. The identification code is, for example, a character string having a plurality of alphanumeric characters. Then, as shown in FIG. 6, in step SP4, the processing circuit 21 determines whether or not power-off was instructed by pressing a power button of the projector 20 or the like. When the determination result of step SP4 is positive, the processing circuit 21 ends the series of processes shown in FIG. 6.

When the determination result of step SP4 is negative, the processing circuit 21 determines whether or not the wired cable CB is electrically connected in step SP6 as shown in FIG. 6. When the determination result of step SP6 is positive, the information processing device 10a_1 and the projector 20 execute the wired communication establishment process corresponding to the wired cable CB in step SP8, and the communication between the information processing device 10a_1 and the projector 20 is established. After the process of step SP8 is completed, the processing circuit 21 executes the process of step SP4 again.

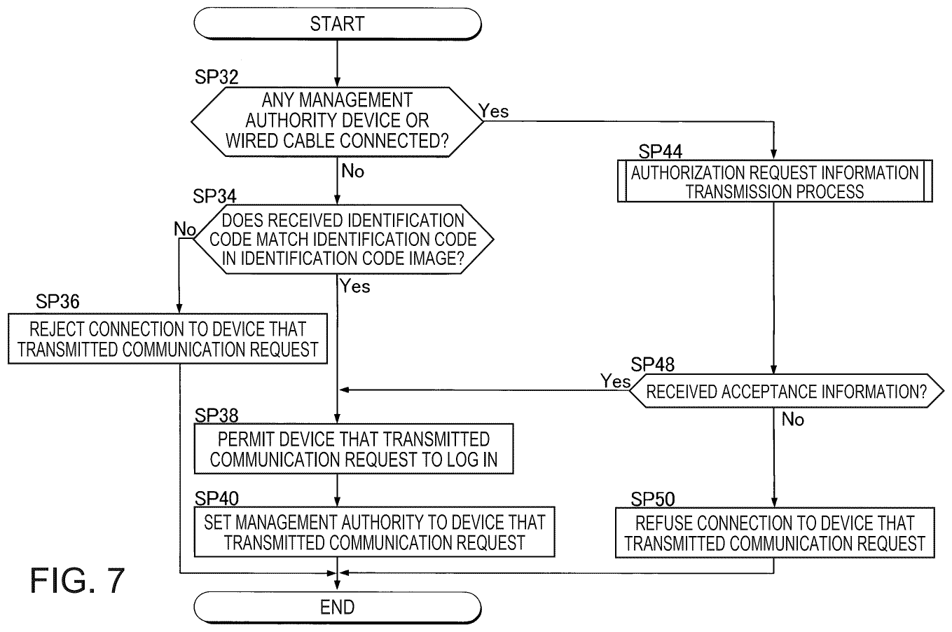

When the determination result of step SP6 is negative, then as shown in FIG. 6, the processing circuit 21 determines whether or not a communication request was received by wireless communication in step SP12. When a determination result of step SP12 is positive, the processing circuit 21 executes a process for when receiving a communication request in step SP14 as shown in FIG. 6. The process for when receiving a communication request will be described with reference to FIG. 7.

FIG. 7 is a flowchart showing an example of the process for when receiving a communication request. In step SP32, the processing circuit 21 determines whether or not there is a management authority device or whether the wired cable CB is connected to the projector 20. The case where the determination result of step SP32 is negative is a case where the projector 20 receives the communication request through the wireless communication in a state where there is no management authority device and the wired cable CB is not connected to the projector 20. Hereinafter, a process in a case where the determination result of step SP32 is negative will be described.

When the determination result of step SP32 is negative, as shown in FIG. 7, in step SP34, it is determined whether or not an identification code included in the received communication request matches an identification code included in an identification code image. When the determination result of step SP34 is negative, in step SP36 the processing circuit 21 rejects communication with the device that transmitted the communication request, and ends the series of processes shown in FIG. 6. Under instruction of the processing circuit 21, the wireless communication circuit 24 transmits a rejection response to the device that transmitted the communication request, as an example of rejection of communication with the device. The rejection response includes, for example, an identifier indicating that an identification code input by a user is incorrect.

When the determination result in step SP34 is positive, then as shown in FIG. 7, the processing circuit 21 gives login permission to the device that transmitted the communication request in step SP38, and the device that transmitted the communication request logs in to the projector 20. Next, as shown in FIG. 7, in step SP40, the processing circuit 21 sets management authority to the device that transmitted the communication request, and ends the series of processes shown in FIG. 7. The device that was set to have management authority in step SP40 is a wireless management authority device.

The description is returned to FIGS. 4 and 6. In the example of FIG. 4, it is assumed that, after the wired communication establishment process is executed, the information processing device 10a_1 starts transmitting image data to the projector 20 in step SC2. In particular, the information processing device 10a_1 transmits the image data to the projector 20 via the wired cable CB.

When the determination result of step SP12 is negative, then as shown in FIG. 6 in step SP16, the processing circuit 21 determines whether or not reception of image data started. When the determination result of step SP16 is positive, then as shown in FIGS. 4 and 6, in step SP18 the projection device 27 starts projecting an image based on the received image data, based on the instruction of the processing circuit 21. An image based on image data may be the image itself indicated by the image data, a portion of the image indicated by the image data, or an image in which another image is superimposed on the image, or on a portion of the image, that was indicated by the image data. The other image is, for example, a character string indicating the current time, or an OSD image in which a position and contrast of the image can be operated. OSD is an abbreviation for On Screen Display. The image projected by the projection device 27 based on the image data transmitted from the information processing device 10a_1 is an example of a “first image”.

Note that in step SP22, when image data is received from two or more devices, the projection device 27 projects an image based on the image data received from each of the two or more devices into respective divided regions of the projection region PR. After completing the process of step SP22, the processing circuit 21 executes the process of step SP4 again.

When the determination result of step SP16 is negative, the processing circuit 21 determines whether or not reception of the image data has completed in step SP20, as shown in FIG. 6. When a determination result of step SP20 is positive, then as shown in FIG. 6, the projection device 27 ends the projection of an image based on the received image data, based on the instruction of the processing circuit 21 in step SP22.

In step SP22, when image data is being received from three or more devices and reception of image data from one device ends, the projection device 27 reduces the number of divisions of the projection region PR and projects an image based on the image data received from each of the two or more devices. When image data is being received from two devices and reception of image data from one of the devices ends, the projection device 27 cancels the division of the projection region PR and projects an image based on the image data received from the remaining one device.

After completing the process of step SP22, the processing circuit 21 executes the process of step SP4 again. When a determination result of step SP20 is negative, the processing circuit 21 executes the process of step SP4 again.

In FIG. 4, it is assumed that, after the projection device 27 starts projecting an image in step SP18, in step SC4, the information processing device 10b_1 transmits a communication request to the projector 20 in accordance with the communications protocol adopted by the projector display control program PRJ. When the projector 20 receives the communication request, the processing circuit 21 determines that the determination result in step SP12 is positive, and further determines that the determination result of step SP32 in FIG. 7 is positive because a wired cable CB is connected to the projector 20.

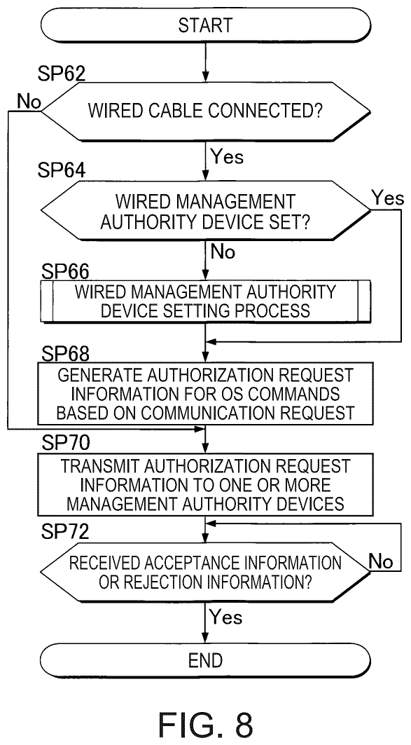

When the determination result of step SP32 is positive, the processing circuit 21 executes an authorization request information transmission process in step SP62. The authorization request information transmission process will be described with reference to FIG. 8.

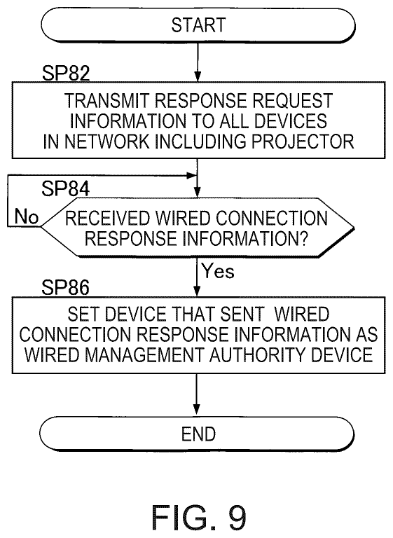

FIG. 8 is a flowchart showing an example of the authorization request information transmission process. In FIGS. 8 and 9, the network NSa is 192.168.13.0/24 and the network NSb is 10.0.10.0/24. Further, the description will be made assuming that 192.168.13.221 is the IP addresses of the projector 20, 192.168.13.6 is the IP addresses of the information processing device 10a_1, and 10.0.10.4 is the IP addresses of the information processing device 10b_1. IP is an abbreviation for Internet Protocol.

The processing circuit 21 determines whether or not the wired cable CB is connected to the projector 20 in step SP62. When the determination result of step SP62 is positive, the processing circuit 21 determines in step SP64 whether or not a wired management authority device is set. When the determination result of step SP64 is negative, the processing circuit 21 executes a wired management authority device setting process in step SP66. The wired management authority device setting process will be described with reference to FIG. 9.

FIG. 9 is a flowchart showing an example of the wired management authority device setting process. As shown in FIGS. 4 and 9, in step SP82, the processing circuit 21 transmits response request information to all the devices in the network NSa including the projector 20. The response request information is realized by a command that can be executed by the OS in the standard state. A command that can be executed by the OS in the standard state may be referred to as an “OS command” below. For example, when the OSs of all the devices belonging to the network NSa are Windows, this is realized by the msg command, which is an example of an OS command. An example of transmission of the response request information by the msg command is as follows.
msg Console/server:192.168.13.255 “connect to HDMI1 response to 192.168.13.221”.

In the above command, the character string surrounded by double quotation marks corresponds to the response request information. 192.168.13.255 is a broadcast address transmitted to all the devices in the network NSa indicated by 192.168.13.0/24. The broadcast address transmitted to all the devices in the network NSa is not limited to 192.168.13.255, and may be, for example, 255.255.255.255.

Upon receiving the response request information, all the devices in the network NSa transmit either a wired connection response signal or a non-wired connection response signal to the projector 20 by the function of the communication program PRT. More specifically, among all the devices in the network NSa, the information processing devices 10 connected to the projector 20 by wired cable CB transmit the wired connection response signal to the projector 20 via the wired cable CB. On the other hand, the information processing devices 10 that are not connected to the projector 20 via the wired cable CB transmit the non-wired connection response signal to the projector 20. All the devices in the network NSa transmit either a wired connection response signal or a non-wired connection response signal to the projector 20 via the network NSa.

However, when a wired connection response signal can be transmitted by the wired cable CB, the information processing device 10 connected to the projector 20 by the wired cable CB may transmit the wired connection response signal to the projector 20 via the wired cable CB. The case where the wired connection response signal can be transmitted by the wired cable CB is, for example, a case where the wired cable CB is compliant with USB Type-C and operates in the alternate mode.

In the example shown in FIG. 4, the information processing device 10a_2 transmits the non-wired connection response signal to the projector 20 in step SC6, and the information processing device 10a_1 transmits the wired connection response signal to the projector 20 in step SC8.

An example of transmission of the wired connection response signal by the msg command is as follows.
msg Console/server:192.168.13.221 “connect HDMI1:192.168.13.6”.

In the above command, the character string surrounded by double quotation marks corresponds to a response signal.

An example of transmission of the non-wired connection response signal by the msg command is as follows.
msg Console/server:192.168.13.221 “no connect”.

In the above command, the character string surrounded by double quotation marks corresponds to a response signal.

In the present embodiment, when the information processing device 10 that is not connected to the projector 20 via the wired cable CB receives the response request information, the information processing device 10 transmits the non-wired connection response signal to the projector 20, but does not have to transmit any signal to the projector 20.

After the process of step SP82 is completed, the processing circuit 21 determines whether or not response information of a wired connection was received in step SP84. When the determination result of step SP84 is negative, the processing circuit 21 executes the process of step SP84 again.

When the determination result of step SP84 is positive, then in step SP86 the processing circuit 21 sets the device that transmitted the response information of the wired connection as the wired management authority device. After the process of step SP86 is completed, the processing circuit 21 ends the series of processes shown in FIG. 9 and returns to the process that is the source caller of the series of processes shown in FIG. 9.

The processing circuit 21 executes the series of processes shown in FIG. 9 after receiving a communication request by wireless communication, but may execute the series of processes immediately after the complete of the process of step SP8.

The description returns to FIG. 8. After the process of step SP66 is completed or when the determination result of step SP64 is positive, the processing circuit 21 generates, in step SP68, the authorization request information for the OS command based on the communication request according to the communication protocols adopted by the projector display control program PRJ. In step SP68, it is necessary to convert the communications protocol adopted by the projector display control program PRJ into a communications protocol for OS commands. In step SP68, an example of transmission of the authorization request information by the msg command is as follows.
msg Console/server:192.168.13.6 “A communication request was issued from the address of 10.0.10.14.” Yn Please permit communication from the following URL. Yn http://192.168.13.1/hogehoge.html”.

In the above command, the character string surrounded by double quotation marks corresponds to the authorization request signal. 192.168.13.1 is the IP address of a Web server provided in the network NSa. The URL is an abbreviation of Uniform Resource Locator.

After the process of step SP68 is completed or when the determination result of step SP62 is negative, the processing circuit 21 controls the wireless communication circuit 24 to transmit the authorization request information to one or more management authority devices in step SP70. Immediately after the information processing device 10b_1 transmits a communication request to the projector 20, the only management authority device is the information processing device 10a_1, which is the wired management authority device, and therefore the processing circuit 21 transmits authorization request information to the information processing device 10a_1. Note that when the processing circuit 21 can transmit the authorization request information to the wired management authority device via the wired cable CB, the processing circuit 21 may transmit the authorization request information to the wired management authority device via the wired cable CB. The processing circuit 21 transmits the authorization request information for the OS command generated in step SP68 to the wired management authority device. The processing circuit 21 transmits to the wireless management authority device authorization request information based on the communication request received in step SP12. Note that as can be seen from FIG. 8, when there is no wired management authority device, the processing circuit 21 does not need to execute the process of step SP68.

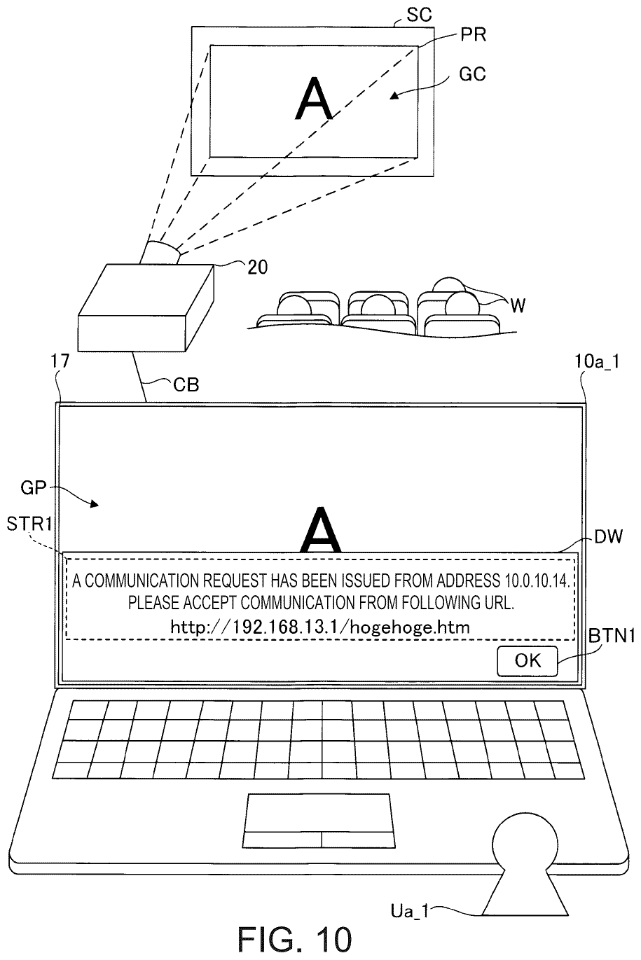

The information processing device 10a_1, which is the wired management authority device that received the authorization request information for the OS command, displays the communication determination dialog DW based on the authorization request information for the OS command on the display section 17. A display example of the communication determination dialog DW will be described with reference to FIG. 10.

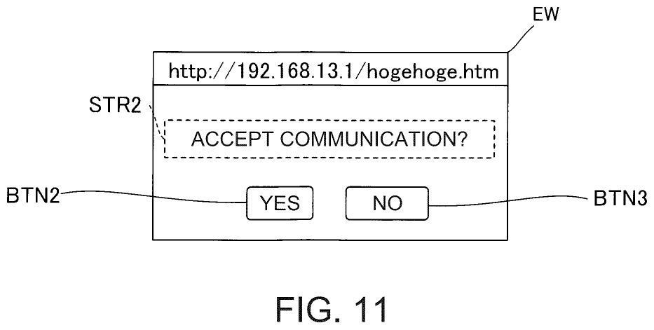

FIG. 10 is a diagram showing an example of the communication determination dialog DW. As shown in FIG. 10, the display section 17 superimposes a communication determination dialog DW on the image GP. In the example of FIG. 10, the communication determination dialog DW includes a character string STR1 and a button BTN1. The character string STR1 matches the character string surrounded by double quotation marks included in the authorization request information for the OS command. The button BTN1 is a button that closes the communication determination dialog DW when pressed. By an operation of the presenter Ua_1, the information processing device 10a_1 accesses the URL included in the character string STR1 by a Web browser application. With reference to FIG. 11, an example will be described of a screen EW that appears after the URL included in the character string STR1 is accessed.

FIG. 11 is a diagram showing an example of a screen EW. The screen EW is an image generated by the web browser application. Although not shown in FIG. 11, the display section 17 superimposes the screen EW on the image GP. The screen EW includes a character string STR2, a button BTN2, and a button BTN3. The character string STR2 is “Do you accept communication?” The button BTN2 on which “YES” is written is a button for transmitting, to the projector 20 by being pressed by the presenter Ua_1, accept information indicating that communication with the projector 20 is accepted. The button BTN3 on which “NO” is written is a button for transmitting, to the projector 20, reject information indicating that communication with the projector 20 is rejected.

The accept information and the reject information can be realized by OS commands. For example, an example of transmission of the accept information by the msg command is as follows.
msg Console/server:192.168.13.221 “accept”.

In the above command, the character string surrounded by double quotation marks corresponds to the accept information.

An example of transmission of the reject information by the msg command is as follows.
msg Console/server:192.168.13.221 “reject”.

In the above command, the character string surrounded by double quotation marks corresponds to the reject information.

As shown in FIG. 10, the communication determination dialog DW is displayed on the display section 17, but is not projected on the projection region PR. Similarly, as understood from FIG. 11, the screen EW is displayed on the display section 17, but is not projected on the projection region PR.

The description is returned to FIGS. 4 and 8. After the process of step SP70 is completed, the processing circuit 21 determines in step SP72, as shown in FIG. 8, whether or not accept information or reject information was received from any of one or more management authority devices. When the determination result of step SP72 is negative, the processing circuit 21 executes the process of step SP72 again. If the determination result of step SP72 is positive, the processing circuit 21 completes the series of processes shown in FIG. 8, and returns to the processes of the source caller of the series of processes shown in FIG. 8.

The description is returned to FIGS. 4 and 7. After the process of step SP44 is completed, then in step SP48 the processing circuit 21 determines whether or not accept information was received. In the example shown in FIG. 4, it is assumed that the button BTN2 is pressed by operation of the presenter Ua_1 and the information processing device 10 transmits accept information to the projector 20 in step SC10. Accordingly, the processing circuit 21 determines that the determination result of step SP48 is positive.

When the determination result of step SP48 is positive, the processing circuit 11 executes the process of step SP38 to give permission for login, in the example of FIG. 4, to the information processing device 10b_1.

When the determination result in step SP48 is negative, that is, when reject information was received, the processing circuit 21 denies communication with the device that transmitted the communication request in step SP50 as shown in FIG. 7, and completes the series of processes shown in FIG. 7. The process of step SP50 is the same as the process of step SP36, but the content of the rejection response of step SP50 may be different from the content of the rejection response of step SP36. The rejection response of step SP50 includes, for example, an identifier indicating that communication was rejected by the user of the information processing device 10 that has management authority of the projector 20.

In the example shown in FIG. 4, it is assumed that, after the processing circuit 21 executes the process of step SP38 and the information processing device 10b_1 logs in to the projector 20, the information processing device 10b_2 transmits a communication request to the projector 20 in step SC12 as shown in FIG. 5.

When the communication request is received, the processing circuit 21 determines that the determination results of step SP12 and step SP32 are positive. Then, the processing circuit 21 executes the process of step SP70. Immediately after the information processing device 10b_2 transmits a communication request to the projector 20, there are two management authority devices, that is, the information processing device 10a_1, which is a wired management authority device, and the information processing device 10b_1, which is a wireless management authority device, so the processing circuit 21 transmits authorization request information to the information processing device 10a_1 and the information processing device 10b_1 as shown in FIG. 5.

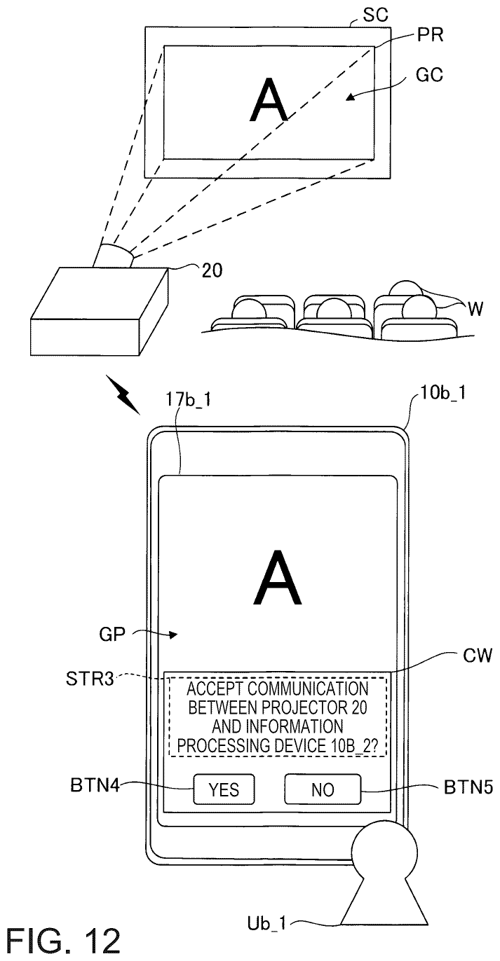

The information processing device 10b_1 displays the communication determination image CW generated by the function of the projector display control program PRJ on the display section 17 based on the authorization request information. A display example of the communication determination image CW will be described with reference to FIG. 12.

FIG. 12 is a diagram showing an example of the communication determination image CW. As shown in FIG. 12, the display section 17b_1 of the information processing device 10b_1 superimposes the communication determination image CW on the image GP. In the example of FIG. 12, the communication determination image CW includes a character string STR3, a button BTN4, and a button BTN5. The character string STR3 is “Do you accept communication between the projector 20 and the information processing device 10b_2? The button BTN4 is a button for, when pressed by the presenter U, transmitting, to the projector 20, accept information indicating that communication with the projector 20 is accepted. The button BTN5 is a button for transmitting, to the projector 20, reject information indicating that communication with the projector 20 was rejected.

As shown in FIG. 12, the communication determination image CW is displayed on the display section 17b_1, but is not projected on the projection region PR.

The description returns to FIG. 5. In the example shown in FIG. 5, it is assumed that the button BTN2 is pressed by operation of the presenter Ua_1 and the information processing device 10 transmits the accept information to the projector 20 in step SC14. Therefore, as shown in FIGS. 5 and 7, in step SP38, permission to log in is given to the information processing device 10b_2, which is the device that transmitted the communication request, and the information processing device 10b_2 logs in to the projector 20.

### 1-4. Summary of the First Embodiment

In the following description, the summary of the first embodiment will be described assuming that communication between the information processing device 10a_1 and the projector 20 is the first communication, communication between the information processing device 10b_1 and the projector 20 is the second communication, communication between the information processing device 10b_2 and the projector 20 is the third communication, and the image projected by the projection device 27 based on the image data transmitted from the information processing device 10a_1 is the first image.

The display system 1 in the first embodiment is a system including the information processing device 10a_1, the information processing device 10b_1, and the projector 20 in which the first communication was established with the information processing device 10a_1 via the wired cable CB, which is capable of communicating with the information processing device 10b_1, and which is capable of displaying an image in the projection region PR. Further, the display system 1 executes a method of controlling communication between the projector 20 and the information processing device 10b_1. The information processing device 10a_1 and the projector 20 are capable of communicating with each other via the network NSa, the information processing device 10a_1 does not store the projector display control program PRJ, whereas the information processing device 10b_1 stores the projector display control program PRJ. When the projector 20 receives authorization request information from the information processing device 10b_1 via the projector display control program PRJ, requesting the second communication between the information processing device 10b_1 and the projector 20 while displaying the first image in the projection region PR, the projector 20 transmits authorization request information indicating that a request was made to the information processing device 10a_1 via the network NSa or the wired cable CB, and when the projector 20 receives accept information indicating that the second communication was permitted from the information processing device 10a_1 via the network NSa or the wired cable CB, the projector 20 establishes the second communication.

As described above, the communication determination dialog DW based on the authorization request information is displayed on the display section 17a_1, but is not projected on the projection region PR, and thus, the projection of the image GP displayed on the projector 20 is not interfered with. Further, the information processing device 10b_1 can log in to the projector 20. Therefore, according to the first embodiment, even in a situation in which the information processing device 10 having the projector display control program PRJ is not communicating with the projector 20, the information processing device 10a_1 connected to the projector 20 via a wired cable CB allows the information processing device 10b_1 to log in to the projector 20.

The display system 1 includes the information processor 10b_2 capable of communicating with the projector 20, the information processor 10b_2 stores the projector display control program PRJ, when the projector 20 further receives a signal from the information processing device 10b_2 requesting permission to perform the third communication between the information processing device 10b_2 and the projector 20 by the projector display control program PRJ while displaying the first image in the projection region PR, the projector 20 transmits authorization request information to both the information processing device 10a_1 and the information processing device 10b_1, and when accept information indicating that the third communication is permitted is received from the information processing device 10a_1 or the information processing device 10b_1, the third communication is established.

According to the first embodiment, the information processing device 10b_2 can establish communication with the projector 20 while preventing the display of the image GP based on the image data transmitted from the information processing device 10a_1 from being interfered with. Further, either the information processing device 10a_1 or the information processing device 10b_1 may transmit accept information or reject information to the projector 20. Therefore, according to the first embodiment, compared to the configuration in which one information processing device 10 is capable of transmitting accept information or reject information, it is possible to prevent delays in acceptance of the third communication due to malfunctions such as delays in communication in the display system 1 or due to the carelessness of the presenter U.

### 2. MODIFICATIONS

Each of the embodiments shown above can be modified in various ways. Specific modified aspects that can be applied to the above-described embodiments will be exemplified below. Two or more aspects arbitrarily selected from the following examples may be appropriately combined as long as they do not contradict each other.

### 2-1. First Modification

In the first modification, when there are two or more management authority devices, the authorization request information is transmitted to the management authority device that does not transmit image data to the projector 20. Hereinafter, a first modification will be described.

### 2-1-1. Operation of First Modification

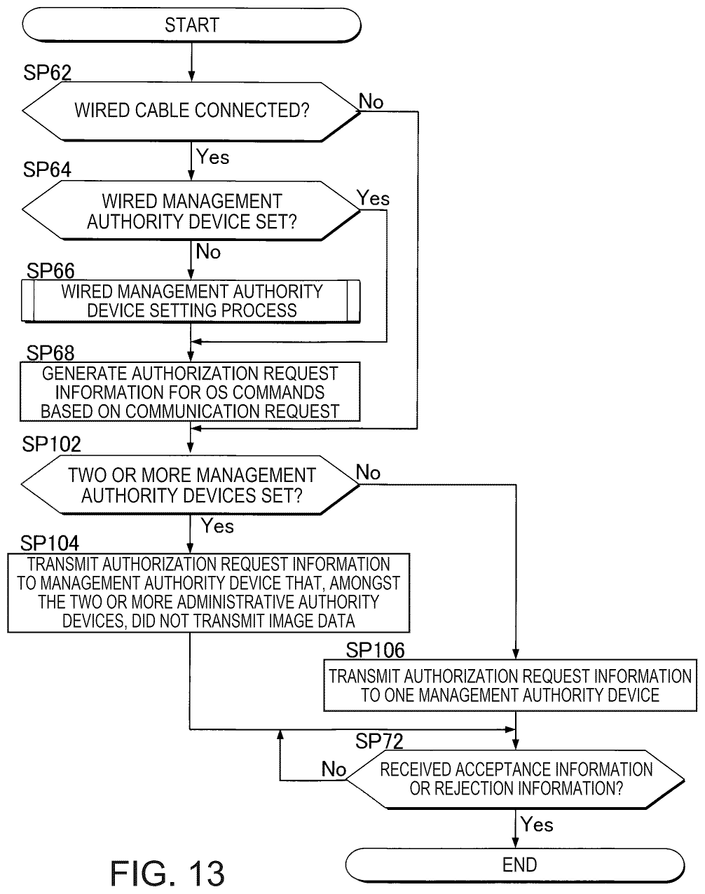

FIG. 13 is a flowchart showing an example of the authorization request information transmission process in the first modification. The flowchart shown in FIG. 13 differs from the flowchart shown in FIG. 8 in that, instead of step SP70, the flowchart executes two out of three steps SP102, SP104, and SP106, but the other parts are the same. Hereinafter, only the differences from the flowchart shown in FIG. 8 will be described.

After the process of step SP68 is completed or when the determination result of step SP62 is negative, the processing circuit 21 determines whether or not there are two or more management authority devices in step SP102. When the determination result of step SP102 is positive, then in step SP104, the processing circuit 21 transmits the authorization request information to the management authority device that, among the two or more management authority devices, is not transmitting image data to the projector 20. On the other hand, when the determination result of step SP102 is negative, the processing circuit 21 transmits the authorization request information to one management authority device in step SP106. After the process of step SP104 is completed, or after the process of step SP106 is completed, the processing circuit 21 completes the process of step SP72.

For example, it is assumed that there are two management authority devices of the information processing device 10a_1 and the information processing device 10b_1, that the information processing device 10b_1 transmits the image data to the projector 20, and that the information processing device 10a_1 does not transmit image data to the projector 20. Assuming this, then when the projector 20 receives a communication request from the information processing device 10b_2 to communicate with the projector 20, then in step SP104 the projector 20 transmits the authorization request information to the information processing device 10a_1, which is not transmitting image data to the projector 20.

### 2-1-2. Summary of First Modification

Hereinafter, an image based on the image data transmitted from the information processing device 10b_1 will be referred to as a second image, and the first modification will be summarized.

When a third communication between the information processing device 10b_2 and the projector 20 is requested by the information processing device 10b_2 while the second image is being displayed in the projection region PR, the projector 20 further transmits authorization request information indicating that the third communication was requested to the information processing device 10a_1, and when accept information indicating that the third communication was accepted is received from the information processing device 10a_1, the third communication is established.

The presenter U may give an explanation while looking at an image displayed on the display section 17 of the information processing device 10 operated by the presenter U. When the information processing device 10b_1 is transmitting image data to the projector 20, there is a high possibility that the presenter Ub_1 is explaining about the second image. Therefore, if the authorization request information were to be transmitted to the information processing device 10b_1, the communication determination image CW based on the acceptance request information would be superimposed on the image displayed on the display section 17, and the presenter Ub_1 may feel annoyed. In the first modification, it is possible to suppress the presenter Ub_1 from feeling of annoyance, compared to the aspect in which the authorization request information is transmitted to the information processing device 10b_1.

### 2-2. Second Modification

In the first embodiment, when there are two or more management authority devices, the processing circuit 21 transmits the authorization request information to both of the two or more management authority devices, but the present disclosure is not limited to this. In the second modification, the authorization request information is transmitted to the wireless management authority device among two or more management authority devices. Hereinafter, the second modification will be described.

### 2-2-1. Operation of Second Modification

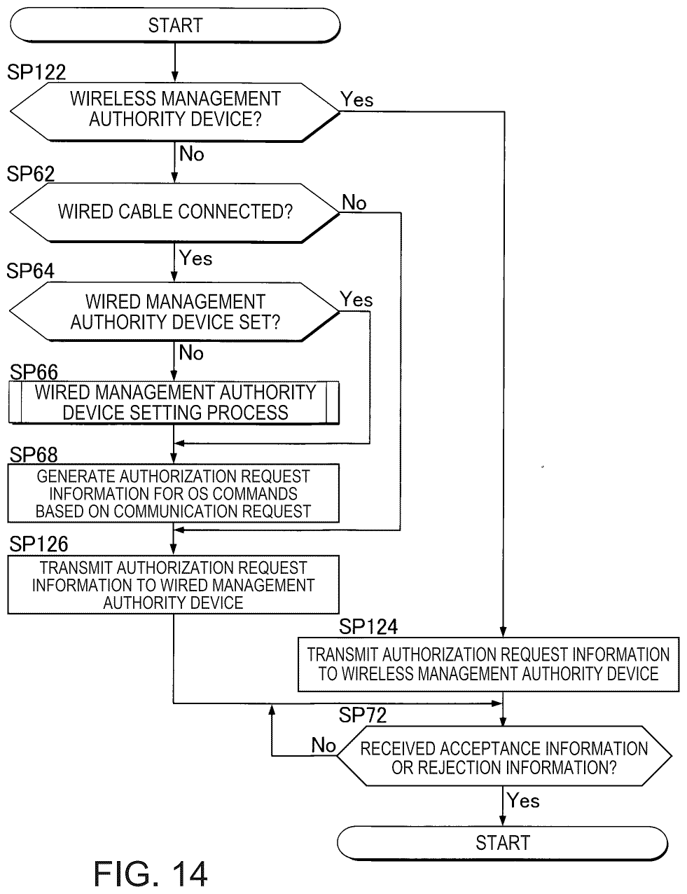

FIG. 14 is a flowchart showing an example of the authorization request information transmission process in the second modification. The flowchart shown in FIG. 14 differs from the flowchart shown in FIG. 8 in that it first executes the judgment process of step SP122, executes the process of step SP124 if the judgment result of step SP122 is positive, and executes the process of step SP126 instead of step SP70, but the other parts are the same. Hereinafter, only the differences from the flowchart shown in FIG. 8 will be described.

In step SP122, the processing circuit 21 determines whether there is management authority device that is a wireless management authority device. When the determination result of step SP122 is negative, the processing circuit 21 executes the process of step SP62. On the other hand, when the determination result of step SP122 is positive, then in step SP124 the processing circuit 21 transmits the authorization request information to the wireless management authority device.

After the process of step SP68 is completed or when the determination result of step SP62 is negative, the processing circuit 21 transmits authorization request information to the wired management authority device in step SP126. After the process of step SP124 or step SP126 is completed, the processing circuit 21 executes the process of step SP72.

For example, if there are two management authority devices of the information processing device 10a_1 and the information processing device 10b_1, the processing circuit 21 determines that step SP122 is positive because, among the two management authority devices, the information processing device 10b_1 is a wireless management authority device. Therefore, in step SP124, the processing circuit 21 transmits authorization request information to the information processing device 10b_1.

### 2-2-2. Summary of Second Modification

Hereinafter, the second modification will be summarized referring to the image projected by the projection device 27 based on the image data transmitted from the information processing device 10a_1 as a first image.

When a third communication between the information processing device 10b_2 and the projector 20 is requested by the information processing device 10b_2 while the first image is being displayed in the projection region PR, the projector 20 further transmits, to the information processing device 10b_1, authorization request information indicating that the third communication was requested, and when accept information indicating that the third communication was accepted is received from the information processing device 10b_1, the third communication is established.

As can be understood from FIG. 14, when the authorization request information is transmitted only to the wireless management authority device, the process of step SP68 may not be executed. Therefore, according to the second modified example, compared with the first embodiment, it is not necessary to execute the process of converting the communication protocol adopted by the projector display control program PRJ into the communication protocol for the OS command, and thus, it is possible to reduce the load on the processing circuit 21.

### 2-3. Third Modification

In the first embodiment, when there are two management authority devices, namely, a wired management authority device and a wireless management authority device, the processing circuit 21 transmits the authorization request information to both of the two management authority devices. In the second modification, the authorization request information is transmitted to the wireless management authority device of the two management authority devices, but the present disclosure is not limited to this. For example, the processing circuit 21 may transmit the authorization request information to the wired management authority device of the two management authority devices. Encompassing the first embodiment, the second modification, and the third modification, the processing circuit 21 transmits the authorization request information to one or both of the two management authority devices of the wired management authority device and the wireless management authority device.

### 2-4. Fourth Modification

In each of the aspects described above, the projector 20 is an example of the “display device”, but the disclosure is not limited to this. For example, as an other example of the display device, an organic EL display or a liquid crystal display may be used. EL is an abbreviation for Electro Luminescence.

### 2-5. Fifth Modification

In each of the aspects described above, the display section of a management authority device is shown as an example of an output destination of information for causing the presenter U to determine whether or not to accept the communication, but the output destination is not limited to the display section of a management authority device. For example, when the management authority device is a wireless management authority device, the wireless management authority device has an earphone, and the presenter U wears the earphone. The wireless management authority device may reproduce, using the earphone, audio indicating information for causing the presenter U of the management authority device to determine whether or not to accept communication between the information processing device 10 and the projector 20, and audio prompting acceptance or rejection of the communication. Audio indicating information for allowing the presenter U of the wireless management authority device to decide whether or not to accept communication between the information processing device 10 and the projector 20 is, for example, “Do you accept communication between the projector 20 and the information processing device 10?”. Audio prompting acceptance or rejection of the communication is, for example, “Press the determination key if the communication is accepted, and press the cancel key if the communication is rejected”. When the determination key is pressed, the wireless management authority device transmits accept information to the projector 20, and when the cancel key is pressed, the wireless management authority device transmits reject information to the projector 20.

### 3. NOTES

Hereinafter, a summary of the present disclosure is appended.

### First Note

A control method for a display system including a first device, a second device, and a display device that establishes first communication with the first device via a wired cable, that is capable of communicating with the second device, and that is capable of displaying an image in a display region, wherein the first device and the display device are configured to communicate with each other via a network, the first device does not store an application program, the second device stores the application program, and the display device when information from the second device requesting a second communication between the second device and the display device is received by the application program while a first image is being displayed in the display region, transmits, to the first device via the network or the wired cable, information indicating that the second communication was requested and when information indicating that the second communication was accepted is received from the first device via the network or the wired cable, establishes the second communication.

According to first note, the second communication is established by the display device sending information indicating that the second communication was requested to the first device via a network or a wired cable, and receiving information indicating that the second communication was accepted from the first device via the network or the wired cable. By this, when the display device is requested to perform the second communication, the second communication can be established even if an image including an identification code is not displayed on the display device, and the display of an image on the display region can be suppressed from being interfered with.

### Second Note

The control method according to the first note, wherein the display system includes a third device configured to communicate with the display device, the third device stores the application program, and the display device further when information from the third device requesting a third communication between the third device and the display device is received by the application program while the first image is being displayed in the display region, transmits information indicating that the third communication was requested to one or both of the first device and the second device and when the display device receives information from the first device or the second device indicating that the third communication was accepted, establishes the third communication.

According to second note, the third communication is established by the display device sending information to one or both of the first device and the second device indicating that the third communication was requested, and receiving information from the first device or the second device indicating that the third communication was accepted. This makes it possible to suppress delays in acceptance of the third communication due to malfunctions such as delays in communication in the display system or carelessness of the users of the first and second devices, compared to a configuration in which the requested information is sent to one of the first and second devices.

### Third Note

The control method according to the first note, wherein the display system includes a third device configured to communicate with the display device, the third device stores the application program, and the display device further when the third device requests a third communication between the third device and the display device while a second image based on image data transmitted from the second device is being displayed in the display region, transmits, to the first device, information indicating that the third communication was requested to the first device and when information indicating that the third communication was accepted is received from the first device, establishes the third communication.

According to third note, the display device establishes the third communication by sending information to the first device indicating that the third communication was requested, and receiving information from the first device indicating that the third communication was accepted. Accordingly, even if the second device does not accept the third communication while the display device displays the second image based on the image data transmitted from the second device in the display region, the first device accepts the third communication, and thus it is possible to suppress the workload of the user of the second device.

### Fourth Note

The control method according to the first note, wherein the display system includes a third device configured to communicate with the display device, the third device stores the application program, and the display device further when a third communication between the third device and the display device is requested from the third device while the image is being displayed in the display region, transmits, to the second device, information indicating that the third communication was requested and when information indicating that the third communication was accepted is received from the second device, establishes the third communication.

According to fourth note, the display device that was requested to establish a third communication by a third device that stores an application program transmits information indicating that the third communication was requested to a second device that stores the application program, and establishes the third communication by receiving information from the second device indicating that the third communication was accepted. Accordingly, even if the display device does not convert the communication protocol adopted by the application program into the communication protocol for the OS command, the information indicating that the third communication is requested can be transmitted from the display device to the second device, and the load of the display device can be reduced.

### Fifth Note

A display device that establishes first communication with a first device via a wired cable, that is configured to communicate with a second device, and that is configured to display an image in a display region, wherein the first device and the display device are configured to communicate with each other via a network, the first device does not store an application program, the second device stores the application program, and when information requesting a second communication between the second device and the display device is received from the second device by the application program while the first image is being displayed in the display region, the display device transmits information indicating that the second communication was requested to the first device via the network or the wired cable and when information indicating that the second communication was accepted is received from the first device via the network or the wired cable, the display device establishes the second communication.

According to fifth note, the same effect as that of the first note is obtained.

What is claimed is:

1. A control method for a display system including a first device, a second device, and a display device that establishes first communication with the first device via a wired cable, that is configured to communicate with the second device, and that is configured to display an image in a display region, wherein
the first device and the display device are configured to communicate with each other via a network,
the first device does not store an application program,
the second device stores the application program, and
the display device
when information from the second device requesting a second communication between the second device and the display device is received by the application program while a first image is being displayed in the display region, transmits, to the first device via the network or the wired cable, information indicating that the second communication was requested and
when information indicating that the second communication was accepted is received from the first device via the network or the wired cable, establishes the second communication.

2. The control method according to claim 1, wherein
the display system includes a third device configured to communicate with the display device,
the third device stores the application program, and
the display device further
when information from the third device requesting a third communication between the third device and the display device is received by the application program while the first image is being displayed in the display region, transmits information indicating that the third communication was requested to one or both of the first device and the second device and
when the display device receives information from the first device or the second device indicating that the third communication was accepted, establishes the third communication.

3. The control method according to claim 1, wherein
the display system includes a third device configured to communicate with the display device,
the third device stores the application program, and
the display device further
when the third device requests a third communication between the third device and the display device while a second image based on image data transmitted from the second device is being displayed in the display region, transmits, to the first device, information indicating that the third communication was requested to the first device and
when information indicating that the third communication was accepted is received from the first device, establishes the third communication.

4. The control method according to claim 1, wherein
the display system includes a third device configured to communicate with the display device,
the third device stores the application program, and
the display device further
when a third communication between the third device and the display device is requested from the third device while the first image is being displayed in the display region, transmits, to the second device, information indicating that the third communication was requested and
when information indicating that the third communication was accepted is received from the second device, establishes the third communication.

5. A display device that establishes first communication with a first device via a wired cable, that is configured to communicate with a second device, and that is configured to display an image in a display region, wherein
the first device and the display device are configured to communicate with each other via a network,
the first device does not store an application program,
the second device stores the application program, and
when information requesting a second communication between the second device and the display device is received from the second device by the application program while the first image is being displayed in the display region, the display device transmits information indicating that the second communication was requested to the first device via the network or the wired cable and
when information indicating that the second communication was accepted is received from the first device via the network or the wired cable, the display device establishes the second communication.
